(19) United States
(12) Patent Application Publication
(10) Pub. No.: US 2006/0204700 A1
(43) Pub. Date: Sep. 14, 2006

(54) Expanded content label and related method of manufacture

(75) Inventor: Guy S. Kiraly, Germantown, TN (US)

Correspondence Address: WARNER NORCROSS & JUDD LLP, 900 FIFTH THIRD CENTER, 111 LYON STREET, N.W., GRAND RAPIDS, MI, 49503-2487, US

(73) Assignee: CCL Label, Inc.

(21) Appl. No.: 11/078,172

(22) Filed: Mar. 11, 2005

(51) Int. Cl. B32B 33/00; B32B 37/00

(52) U.S. Cl. 428/40.1; 156/250; 156/297

(57) ABSTRACT

An expanded content label partitioned to provide multiple, independently accessible information fields. In one embodiment, an expanded content label includes an overlaminate and an expanded content device, which includes an information set divided into multiple, different information fields, separated to form a plurality of corresponding label portions. Individual expanded content labels each include the label portions and a complete information set. Optionally, the information fields are in different languages. A related method includes: providing a release liner; joining a plurality of expanded content devices to the release liner, each including an information set divided into different information fields; placing an overlaminate over the expanded content devices; cutting each expanded content device to form separate sub-expanded content devices, each sub-expanded content device corresponding to a different information field; and cutting the overlaminate to form a plurality of individual expanded content labels so that each individual label includes a complete information set.

### BACKGROUND OF THE INVENTION

The present invention relates to labels, and more particularly to an expanded content labels (ECL) and a method for making the same.

Generally, an ECL is a label that provides an increased amount of printed information for inclusion with a product or its packaging. ECLs are increasingly used to replace leaflets, booklets, manuals, tags and other materials otherwise packaged with products to provide information about those products.

A conventional ECL includes a booklet or leaflet that is secured directly to the product or to a base label which secured to the product. Information about the product is printed on or in the booklet. Sometimes, information is printed in different languages so that the product can be distributed in countries where different languages are used, or to provide product information to a multilingual consumer base.

To provide multi-lingual information, many ECLs include a multi-paged booklet. On the first few pages of the booklet, information is provided in a first language, for example, English. In the remaining pages of the booklet, identical information is provided in a second language, for example, Spanish.

Although a common ECL can provide increased information, it suffers several shortcomings. As one example, to access information recorded in one language, the user must thumb through multiple pages of the ECL booklet to the find the foreign text that they require. This can be time consuming, and sometimes frustrating. As another example, some consumers may be offended when the information in their language is on the last page of the booklet, rather than on the first pages. This can alienate the consumer, and possibly prevent them from purchasing the associated products. As a third example, some customers desire to remove information that is not in their preferred language from the ECL. Conventional ECLs fail to provide this feature without damage to the label.

### SUMMARY OF THE INVENTION

The aforementioned problems are overcome in the present invention wherein an expanded content label is partitioned to provide multiple, independently accessible information fields which are included in or on different corresponding expanded content devices.

In one embodiment, an expanded content label includes an overlaminate and an expanded content device which includes an information set divided into multiple, different information fields. The overlaminate and expanded content device are separated to form multiple corresponding label portions. Individual expanded content labels include the multiple label portions so that each individual label includes a complete information set. Optionally, the information fields are instructions or product information, each field being in a different language.

In another embodiment, the expanded content device and/or overlaminate is secured to a label base. Optionally, the overlaminate can extend beyond one or more sides of the expanded content device and can be adhered to the label base. The label base also may be separated into separate label base parts which correspond to different information fields.

A method for manufacturing the label is also provided. In one embodiment, the method includes: providing a release liner; joining expanded content devices to the release liner, each including an information set divided into different information fields; placing an overlaminate over the expanded content devices; cutting each expanded content device to form separate sub-expanded content devices, each sub-expanded content device corresponding to a different information field; and cutting the overlaminate to form a plurality of individual expanded content labels so that each individual label includes a complete information set.

In another embodiment, the method includes: providing a label base web; securing expanded content devices to the web, each device including a complete information set which is divided into a plurality of different information fields; cutting each of the plurality of expanded content devices to form a plurality of separate sub-expanded content devices, each sub-expanded content device corresponding to a different information field; and cutting the web to form a plurality of individual expanded content labels, each label including the complete information set.

The present invention provides simple and inexpensive ECLs having multiple information fields that are easy to identify and independently accessible. Where the information fields are provided in different languages, products labeled with the ECL are readily accepted in multilingual cultures, as well as by multilingual consumer bases.

These and other objects, advantages and features of the invention will be readily understood and appreciated by reference to the detailed description of the invention and the drawings.

### BRIEF DESCRIPTION OF THE DRAWINGS

FIG. 1 is a perspective view of an expanded content label according to the present invention;

FIG. 2 is a perspective view of the expanded content label partially opened;

FIG. 3 is a perspective view of a process for manufacturing expanded content labels;

FIG. 4 is a perspective view of a process for applying expanded content labels to articles;

FIG. 5 is a perspective view of a first alternative embodiment of the expanded content label;

FIG. 6 is a perspective view of a process for manufacturing alternative expanded content labels; and

FIG. 7 is a perspective view of a process for applying alternative expanded content labels to articles.

### DETAILED DESCRIPTION OF THE INVENTION

I. Overview

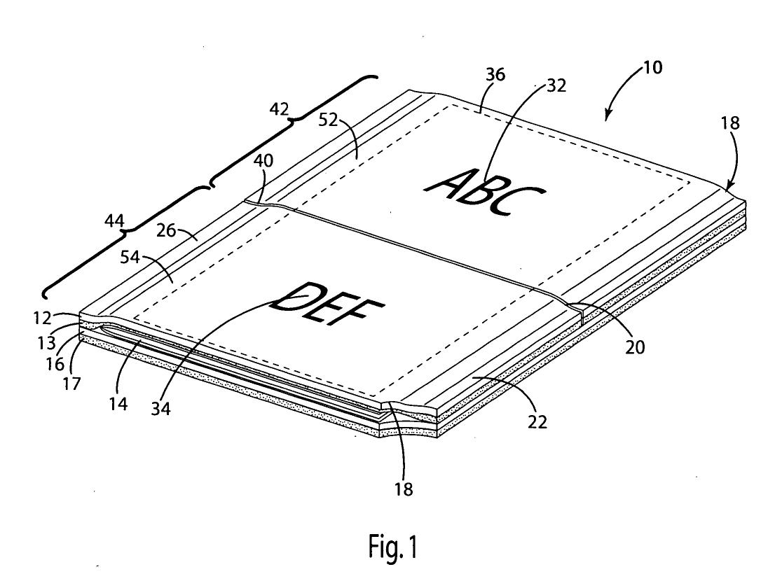

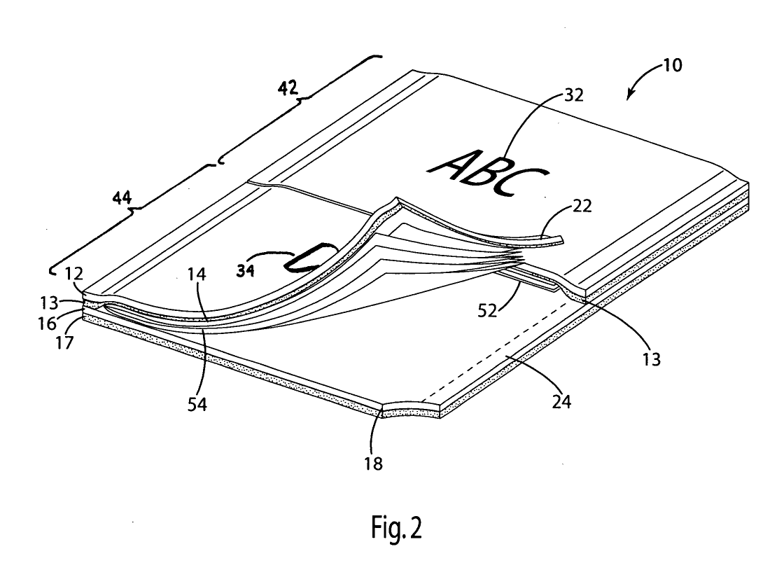

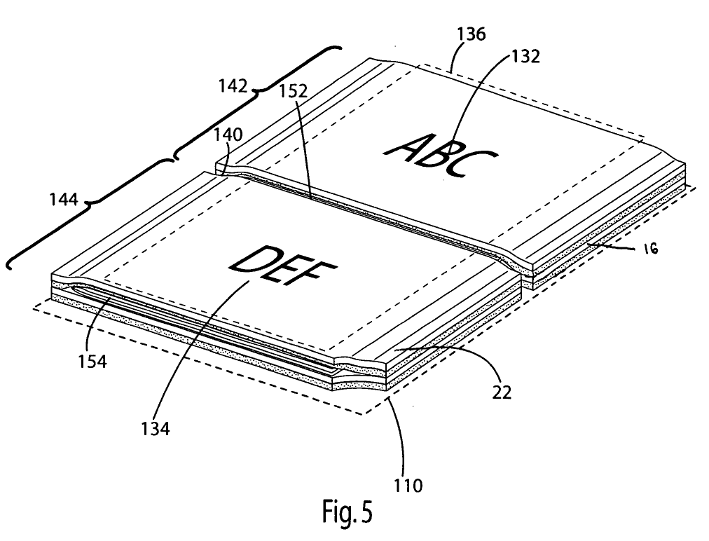

An embodiment of the expanded content label (ECL) of the present invention is illustrated in FIGS. 1 and 2 and generally designated 10. The label 10 includes an overlaminate 12 adhered over an expanded content device 14 to secure the device to an optional base label 16. The expanded content device and/or overlaminate includes information fields 32 and 34, which collectively form an information set 36. The ECL 10 can include a cut 40 which forms a physical separation between label portion 42 and label portion 44. This cut can pass through the overlaminate 12, adhesive 13, and expanded content device 14. Optionally, the cut can also extend through the base label 16 and adhesive 17, to form label portions 142 and 144, which as shown in FIG. 5, form separate sub-labels of ECL 110.

With reference to FIGS. 1 and 2, the cut 40 provides a physical separation of label portions 42 and 44, which include sub-expanded content devices 52 and 54, respectively. With the portions and/or sub-expanded contents separated, a user can open and/or access a selected portion of the expanded content device 14 independently, without having to access another portion of the device. As shown in FIG. 2, for example, a user can independently open label portion 44 and access sub-expanded content device 54, along with whatever information field 34 is associated with, on, or in the sub-expanded content device 54. This independent access is possible because label portion 44 is separate from label portion 42, which can remain in a closed and un-accessed position. In one example, the ECL is useful where the information field 32 includes product instructions written in English, and the information field 34 includes identical instructions written in Spanish. With such an ECL, a Spanish-speaking user can easily access the information field 34 without having to access or otherwise sort through the English information field 32.

II. Construction

With reference to FIGS. 1 and 2, construction of the expanded content label 10 and its components will be described in more detail. The base 16 includes first and second sides. The second, or underside, is coated with an adhesive layer 17, which can cover the entire underside or applied in a pattern on the underside. As noted above, the base label may be entirely absent from the ECL 10 without significantly altering its performance. The expanded content label, the base label and any other components can be manufactured from many materials, including paper, plastic, foil, metals, and the like.

Overlaminate 12 includes an adhesive 13 on its underside. The overlaminate is secured over the expanded content device 14 and as shown, and can secure the device to the base label 16. More specifically, the overlaminate extends beyond the sides of the expanded content device 14 at margins 22 and 26. The margins can include an adhesive 13 that secures them to the base layer 16. In this manner, the expanded content device is sandwiched between the base 16 and the overlaminate 16. Optionally, the adhesive 13 can be a releasable adhesive so that the margins can be easily detached from the base 16. The base 16 optionally can be coated with a release composition 24 in an area corresponding to the location of one or both of the margins to facilitate release of the overlaminate from the base 16. Finally, although the overlaminate as shown in the figures is transparent so that the information fields 34 and 36 on the expanded content device are viewable, it can be opaque or colored as desired. Furthermore, the dimensions of the overlaminate relative to the expanded content device can be altered as desired.

The base label 16 and/or expanded content device 14 can be cut to form an indentation and/or rounded edge 18. This indentation can be a tab which enables a user to grasp the overlaminate 12 and/or device 14 and expose the device 14, or sub-devices 52 or 54.

The expanded content device 14 as shown is a multiple panel, expanded content device in booklet form. The device 14 includes one or more pre-printed pages that are bound or otherwise joined together using conventional methods. The device is pre-printed with directions, product ingredients, installation instructions, product warnings, coupons, advertisements and/or other information. As shown, the device 14 generally has a length that is the same as the base 16.

Although the device 14 shown in the figures is a conventional booklet, including pages or panels stacked in overlying relationship, the device can include any other configuration of single or multiple pages or panels printed with any indicia, including text or graphics of any kind, collectively referred to as information. Information can be printed on the panels using offset, screen or other suitable printing techniques.

As shown in FIGS. 1 and 2, an information set 36 is printed on the first or top page 14 of the device 14. This information set can include at least two different information fields 32 and 34. These information fields can be printed on the overlaminate, the first page of the device, and/or on succeeding inner pages of the booklet. In one embodiment, each entire sub-expanded content device relates to a single different information field. For example, sub-expanded content device 54 includes information field 34, as well as any information relating to the field 34, which is also included in that information field as used herein. As a further example, the information set 36 can include first product instructions in English in information field 32, and second, identical product instructions in Spanish in information field 34. Further information associated with each respective information field 32 and 34 (and thus included in those information fields) can be included in additional pages or panels of the respective sub-devices 52 and 54.

As shown in FIG. 1, the ECL 10 includes a cut 40 which subdivides at least the overlaminate 12 and device 14 to form corresponding portions 42 and 44. Each of these portions also include respective sub-expanded content devices 52 and 54, which include the respective information fields noted above. The cut 40 can optionally extend through the base label 16 as well to form sub-labels as shown in FIG. 5 and further discussed below. The cut can also optionally extend through the overlaminate in the areas of the overlaminate overlying the booklet 14 and the margin 22, but not the margin 26. In this optional construction, the margin 26 maintains its integrity.

With reference to FIG. 2, with the ECL 10, the devices 52 and 54 are independently accessible and/or openable to access selected information fields. For example, a user can grasp the tab 18 associated with sub-device 54 and pull upward so that the margin 22 releases from the coating 24. Accordingly, the sub-expanded content device 54, and its panels previously hidden from view, are accessed. However, because the sub-devices 54 and 52 are physically separated by the cut 40, the sub-device 54 can be accessed independently and separately from the sub-device 52. In this manner, the information field 34 and associated information on the corresponding pages of the sub-device 54 can be reviewed separately and independently from the information field 32 and the other sub-device 52.

After the user has reviewed the information field 34 and any associated panels within the sub-device 54, the user can close the sub-device 54 by resealing the margin 22 against the release coating 24.

II. Method of Manufacture and Application

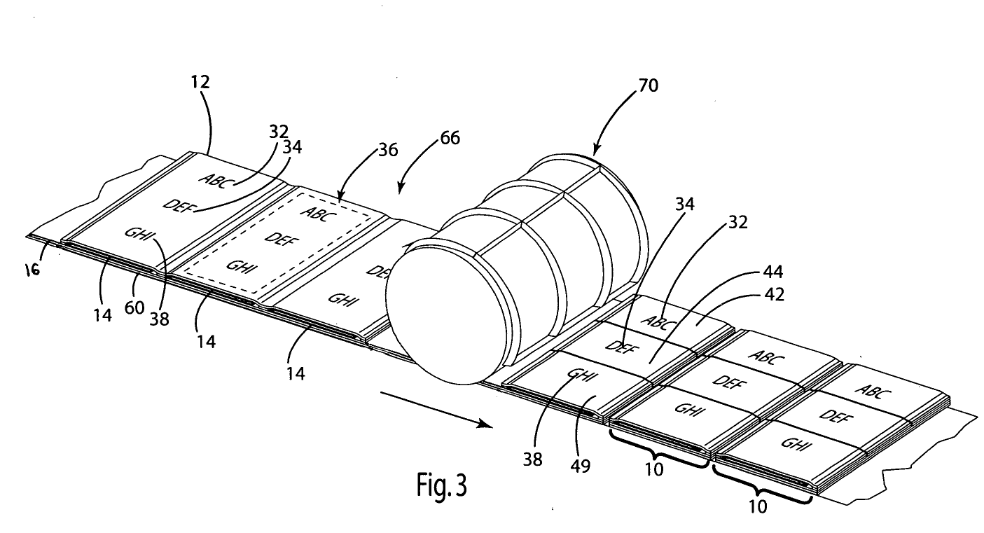

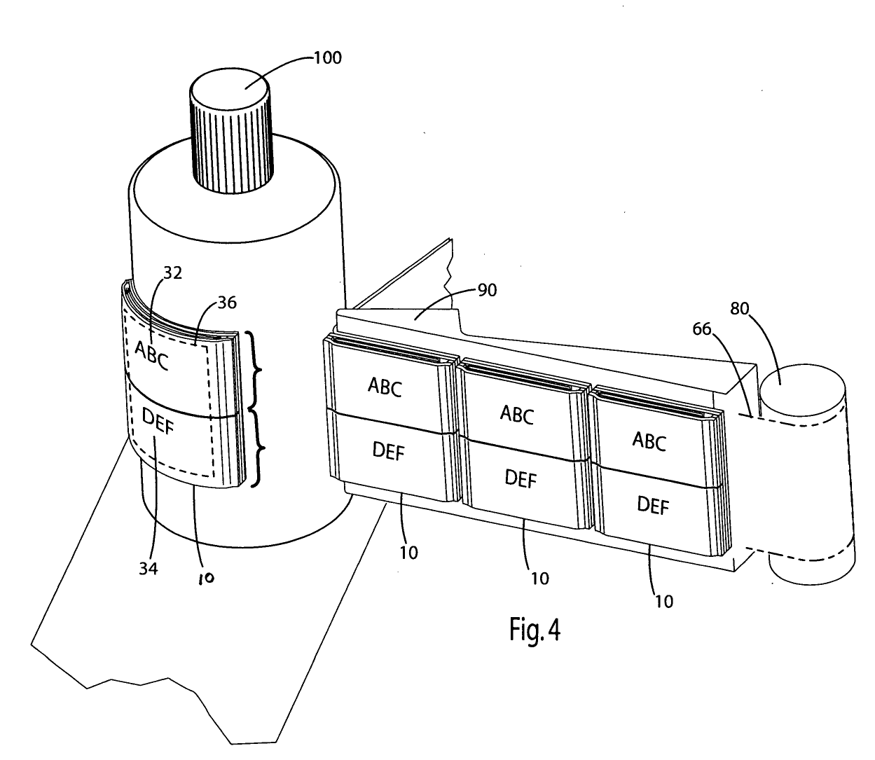

A method of manufacturing and applying the ECL of the invention will now be described in connection with FIGS. 3-4. Although it is possible to produce labels one at a time, the present method produces multiple labels on a continuous web of release material.

The method begins with the continuous web of pressure-sensitive base label stock 16 adhered to a silicone-based release liner 60. The web can be purchased as a prefabricated assembly, however, it also can be custom manufactured to allow patterning of the adhesive as desired. A plurality of expanded content devices 14 are placed on the label stock 16. These devices 14 each include information fields 32, 34 and 38, which collectively form a single or complete information set 36. Optionally, the devices 14 may already be subdivided into sub-devices which include respective individual information fields 32, 34 and 38, as desired.

As shown in FIG. 3, an overlaminate 12 is adhered to the label stock 16 and secured over the devices 14. In embodiments where the label stock 16 is absent, the overlaminate 12 is applied directly over the devices and adhered to the release liner 60, thereby securing those devices 14 to the release liner 60.

The web is advanced to a cutting station 70 which includes die cutting and/or knife cutting machinery. There, the web is cut through the overlaminate 12, device 14 and, optionally the label stock 16. With this cut, each expanded content device is sub-divided into sub-expanded content devices, each sub-device including an information field 32, 34 and 38, which may be printed directly on the respective sub-expanded content device and/or the corresponding portion of the overlaminate 12. At the station 70, the individual ECLs 10 are separated from one another along the respective leading and trailing edge of each ECL. Each resulting ECL 10 includes the multiple sub-devices, and each sub-device includes the associated information fields 32, 34, 38 forming a complete information set. The resulting web, now comprised of multiple individual ECLs 10, can be wound into a spool for further distribution or application.

Referring to FIG. 4, a method for applying the ECL to an article 100 will now be described. As shown, a spool 80 including a wound web 66 of the ECLs 10 of the present invention is advanced to a knife edge applicator 90. Although shown in conjunction with a knife edge applicator, other apparatus may be used to apply the ECLs 10 to an article 100. The applicator 90 peels the ECLs 10 from the release liner 60 to expose the adhesive of the label stock. This adhesive contacts the article 100, and secures the label thereto. Where the label stock is not included, the adhesive on the underside of the overlaminate, along the margins, is exposed to adhere the ECL to the article 100. Other operations may be performed to securely press the ECL onto the article 100 to ensure adequate adhesion. Also, other conventional application machinery may be used as desired.

The article labeled with the ECL 10 subsequently includes a complete information set 36 including both the information fields 32 and 34. Each of these information fields is uniquely associated with a label portion 43 and 45, which can be independently opened to access each of the respective information fields and associated panels.

III. Alternative Embodiment

An alternative embodiment of the ECL of the invention is shown in FIG. 5. This ECL 110 includes all of the components of the above-described ECL 10; however, the label 110 includes a cut 140 that completely separates the ECL 110 into label portions also referred to as sub-labels 142 and 144. The sub labels each include respective sub-devices 152 and 154, and respective information fields 132 and 134, which collectively constitute information set 136. Optionally, each sub-label includes a base 16 as well.

The ECL 110 of this embodiment can be accessed and used in the same manner as the embodiment described above so that sub-devices 152 and 154, and corresponding information fields 132 and 134, are each independently accessible and openable by a user as described above.

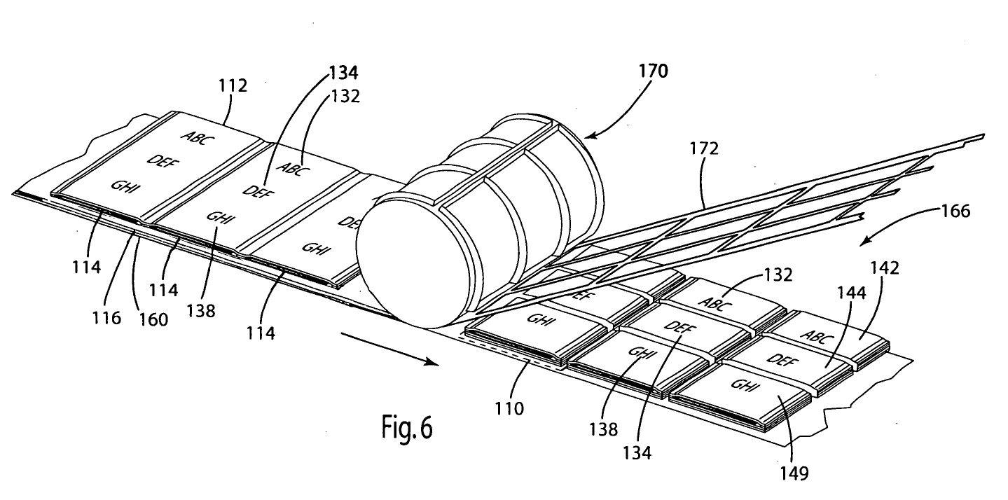

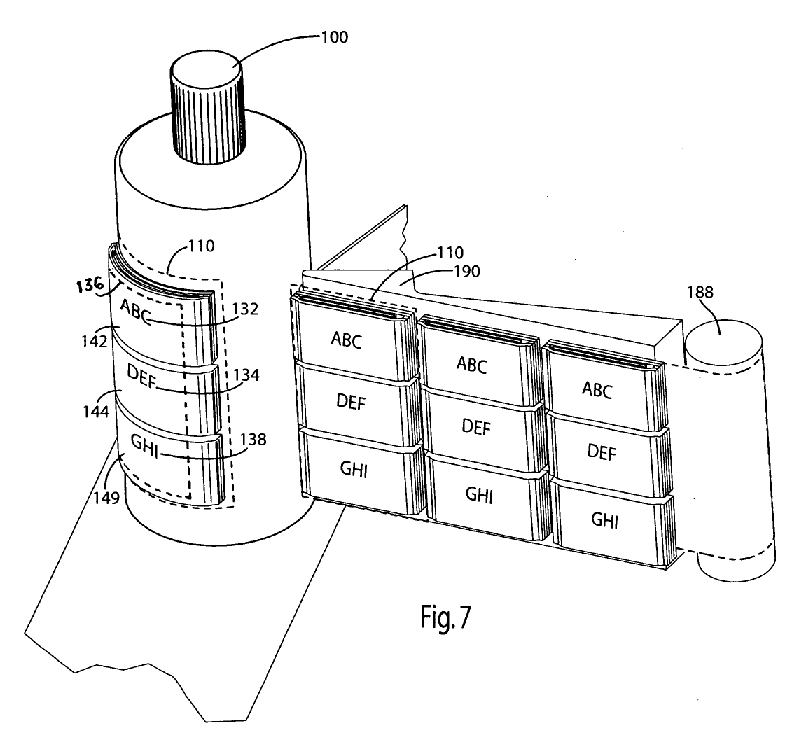

The method for manufacturing the alternative ECLs 110 and applying those ECLs to an article are illustrated in FIGS. 6 and 7. As shown in FIG. 6, a label web 166 comprising a release liner web 160, release liner stock 116, expanded content devices 114 and overlaminate 112 is advanced to a cutting station 170. At the cutting station, cutting machinery cuts the web as shown to form individual sub-labels 142, 144 and 149, which each include corresponding sub-devices and corresponding information fields 132, 134 and 138. The resulting web, now comprised of multiple individual ECLs 110, can be wound into a spool for further distribution or application.

With reference to FIG. 7, the label web 166 is unwound from the spool 180 and passed over an applicator 190 to apply each individual ECL 110 to articles 100. Each article is thus labeled with multiple sub-labels 142, 144 and 149, each including corresponding information fields 132, 134 and 138, which collectively form an information set 136 and associated sub-devices. As described above, each of these information fields 132, 134 and 138 and associated sub-devices can be independently accessed by a user depending on the information desired to be reviewed.

The above descriptions are those of the preferred embodiments of the invention. Various alterations and changes can be made without departing from the spirit and broader aspects of the invention as defined in the appended claims, which are to be interpreted in accordance with the principles of patent law including the doctrine of equivalents. Any references to claim elements in the singular, for example, using the articles “a,” “an,” “the,” or “said,” is not to be construed as limiting the element to the singular.

1. An expanded content label comprising:
a base including a first side and a second side, the first side including an adhesive;
an expanded content device including a first portion having a first information field including information in a first language, and a second portion having a second information field including information in a second language different from the first language, the expanded content device secured to the second side of the base; and
an overlaminate, including a first edge and a second edge, secured over the expanded content device, the second edge extending beyond the expanded content device, the second edge releasably adhered to the second side,
wherein the overlaminate and the expanded content device are cut along a line that physically separates the first portion and the second portion so that the first portion and the second portion are secured to the second side of the base, but are each individually and separately openable, whereby the first information field can be accessed independently from the second information field, and whereby the second information field can be accessed independently from the first information field.

2. The expanded content label of claim 1 wherein the base remains intact when at least one of the first portion and the second portion are opened, although the first portion and second portion are physically separated.

3. The expanded content label of claim 2 wherein the first edge of the overlaminate extends beyond the expanded content device on a side of the expanded content device opposite the second edge and secures the booklet to the base along the second edge.

4. The expanded content label of claim 3 comprising at least one pull tab secured to at least one of a second edge and the expanded content device to facilitate opening the at least one of the first portion and the second portion.

5. The expanded content label of claim 4 wherein the expanded content device includes an upper border and a lower border, the cut line being between the upper border and the lower border.

6. The expanded content label of claim 5 wherein a first pull tab is secured to the at least one of the second edge and the expanded content device adjacent the upper border, and wherein a second pull tab is secured to the at least one of the second edge and the expanded content device near the lower border, the first pull tab enabling only the first portion to be opened by a user, the second pull tab enabling only the second portion to be opened by the user.

7. The expanded content label of claim 1 wherein the base is cut along the line so that a first base part remains secured to the first portion, and so that a second base part remains secured to the second portion, but wherein the first base part and second base part are separated from one another by the line.

8. An label web comprising:
a liner; and
a plurality of individual, expanded content labels joined with the liner, each expanded content label including an expanded content device and an overlaminate secured over the expanded content device, the overlaminate extending past at least one side of the expanded content device, the expanded content device including an information set which includes a plurality of different information fields, the expanded content device and overlaminate separated into a plurality of portions, each portion including one from the plurality of different information fields, wherein each individual expanded content label includes an information set, and wherein each portion is independently operable to provide independent access to each different information field of the individual expanded content label.

9. The label web of claim 8 wherein the overlaminate is releasably adhered over the expanded content device and to the liner to secure the expanded content device to the liner.

10. The label web of claim 8 wherein each individual expanded content label includes a base, the overlaminate adhered over the expanded content device and to the base.

11. The label web of claim 10 wherein the base is separated into a plurality of label base portions, each label base portion joined with a corresponding portion.

12. The label web of claim 8 wherein the overlaminate forms a panel of the expanded content device and includes the plurality of different information fields.

13. The label web of claim 8 wherein each information field is provided in a different language.

14. A method comprising:
providing a release liner;
joining a plurality of expanded content devices to the release liner, each of the expanded content devices including an information set, which is divided into a plurality of information fields;
placing an overlaminate over the plurality of expanded content devices;
cutting each expanded content device to form a plurality of separate sub-expanded content devices, each sub-expanded content device corresponding to a different information field; and
cutting the overlaminate to form a plurality of individual expanded content labels, each expanded content label including the plurality of sub-expanded content devices such that each individual expanded content label includes one complete information set.

15. The method of claim 14 comprising:
securing a label base to the release liner, the label base including a first side releasably adhered to the liner and a second side opposite the release liner; and
securing the plurality of expanded content devices to second side.

16. The method of claim 15 wherein said cutting the overlaminate to form a plurality of individual expanded content labels includes cutting the label base.

17. The method of claim 14 wherein each information field is provided in a different language whereby each individual expanded content label includes information in a plurality of different languages.

18. A method comprising:
providing a label base web having a first side and a second side;
securing a plurality of expanded content devices to the second side, each of the plurality of expanded content devices, each including a complete information set which is divided into a plurality of different information fields;
cutting each of the plurality of expanded content devices to form a plurality of separate sub-expanded content devices, each sub-expanded content device corresponding to a different information field; and
cutting the base label web to form a plurality of individual expanded content labels, each individual label including the complete information set.

19. The method of claim 18 wherein the information fields are provided in different languages.

20. The method of claim 18 comprising transferring an individual expanded content label to an article so the article is labeled with one complete information set.
